(19) United States
(12) Patent Application Publication
(10) Pub. No.: US 2008/0130911 A1
(43) Pub. Date: Jun. 5, 2008

(54) Electronic device Capable of Automatically Discriminating Headset Type and Related Method

(76) Inventor: Kuo-Ting Tsen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/744,887

(22) Filed: May 7, 2007

(30) Foreign Application Priority Data
Dec. 1, 2006 (TW) 095144751

(51) Int. Cl. H04R 1/10

(52) U.S. Cl. 381/74

(57) ABSTRACT

An electronic device capable of automatically determining a headset type includes a headset jack, a detection unit and a discrimination unit. The headset jack includes a plurality of transmission interfaces and is used for exchanging signals with a headset via the plurality of transmission interfaces. The detection unit is coupled to the headset jack and is used for detecting the signals exchanged via the plurality of transmission interfaces. The discrimination unit is coupled to the detection unit and is used for determining the signal allocation of the headset according to the signals exchanged via the plurality of transmission interfaces.

### BACKGROUND OF THE INVENTION

1. Field of the Invention

The present invention relates to an electronic device and related method, and more particularly, to an electronic device capable of automatically determining a headset type and method thereof.

2. Description of the Prior Art

A headset is a miniature audio output device, allowing a user to receive audio sound without disturbing others. As can be seen anywhere, many mobile phones are equipped with a headset jack for outputting voice or music sound. Plugging the headset into the headset jack of the mobile phone enables a user to enjoy multimedia applications or answer the phone. And, under certain circumstances unsuitable for holding the mobile phone with one hand, such as when shopping, driving, exercising, or other circumstances, the user can listen through the headset while still enjoying multimedia applications or answering the phone for purposes of safety and convenience.

Headsets for use with mobile phones commonly can be classified into two types based on different types of headset plugs employed, the two types of headsets including a three-segment type and a four-segment type. The four-segment type headset includes two speakers (left and right channels), a microphone, and a four-segment headset plug, whereas the three-segment type headset includes a microphone, a three-segment headset plug, and only one speaker. Please refer to FIG. 1, which is a schematic diagram of signals and connections of a three-segment headset plug 30, a four-segment headset plug 40, and a four-segment headset jack 50 according to the prior art. The sizes of the three-segment headset plug 30 and the four-segment headset plug 40 are the same, both being capable of plugging into the four-segment headset jack 50. The three-segment headset plug 30 includes transmission interfaces S3_1 to S3_3 used for respectively transmitting a microphone signal MIC, a single audio channel, and a grounding signal GND. The single audio channel is a left-channel signal LCH or a right-channel signal RCH, which are no different to a user, depending on how the user wears the headset. The signals transmitted via the transmission interfaces S3_1 and S3_2 can be exchanged with each other. The four-segment headset plug 40 includes transmission interfaces S4_1 to S4_4 used for respectively transmitting the right-channel signal RCH, the left-channel signal LCH, the microphone signal MIC, and the grounding signal GND. Similarly, the signals transmitted via the transmission interfaces S4_1 to S4_3 can be exchanged with each other. The four-segment headset jack 50 includes transmission interfaces S5_1 to S5_4 respectively coupled to an audio processing unit installed in a mobile phone and used for outputting the left and right channel signals or receiving the microphone signal.

In order to correctly process the audio signals, all signals transmitted via the four-segment headset jack 50 correspond to the transmission interfaces of the three-segment headset plug 30 or the four-segment headset plug 40. However, since signal allocation of a headset jack for use in different mobile phones may not be the same, a user has to choose the headset attached to the mobile phone he purchased. If signal allocation of the headset jack is different from that of the headset, the left-channel, right-channel or microphone signals may not match with audio signal sources when the user utilizes the headset to answer the phone or listen to music. For example, suppose the signal allocation of the four-segment headset jack 50 is: transmission interface S5_1 to the left-channel signal LCH; transmission interface S5_2 to the right-channel signal RCH; transmission interface S5_3 to the microphone signal MIC; and transmission interface S5_4 to the grounding signal GND. As shown in FIG. 1, the signal allocation of the four-segment headset plug 40 may be arranged as follows: transmission interface S4_1 to the right-channel signal RCH; transmission interface S4_2 to the left-channel signal LCH; transmission interface S4_3 to the microphone signal MIC; and transmission interface S4_4 to the grounding signal GND. The transmission interfaces S4_1 to S4_4 can be correspondingly fitted with the transmission interfaces S5_1 to S5_4 when the four-segment headset plug 40 is plugged into the four-segment headset jack 50. In this case, since signal allocation of the left- and right-channel signals is reversed, the left-channel signal LCH transmitted via the transmission interface S5_1 passes through the transmission interface S4_1, and then outputs left-channel audio sounds through the right speaker of the four-segment headset plug 40. As a result, the left- and right-channel signals outputted via the four-segment headset plug 40 are swapped according to the audio signal sources. Fortunately, reversing the left- and right-channel signals makes no difference or negative impact on the user experience.

However, take another case for example. Suppose the signal allocation of the four-segment headset jack 50 is the same as mentioned above, while that of the three-segment headset plug 30 is arranged as follows: transmission interface S3_1 to the microphone signal MIC; transmission interface S3_2 to the left-channel signal LCH; and transmission interface S3_3 to the grounding signal GND. When the three-segment headset plug 30 is plugged into the four-segment headset jack 50, the transmission interfaces S3_1 and S3_2 are coupled to the transmission interfaces S5_1 and S5_2. As can be seen from FIG. 1, the transmission interface S3_3 is coupled with the transmission interfaces S5_3 and S5_4. In this situation, when the mobile phone transmits the left-channel signal LCH via the transmission interface S5_1, the left-channel signal LCH cannot successfully output left-channel audio sounds since the transmission interface S3_1 is coupled to the microphone of the three-segment headset plug 30. Similarly, the transmission interface S5_3 cannot receive the correct microphone signal MIC, so that the user's voice cannot be received and transmitted. As a result, the microphone of the three-segment headset plug 30 cannot function normally, preventing the user from using the hands-free functionality of the mobile phone via the three-segment headset plug 30.

In general, the signal allocation of the headset jacks is configured based on the preference of each manufacturer. For example, when the user purchases a mobile phone, usually the user can only choose the headset manufactured by the same manufacturer as the mobile phone to avoid incompatibility due to different signal allocation of the headset and the headset jack of the mobile phone. In this situation, since each manufacturer has a preference for signal allocation of the headset jack, which means transmission signals corresponding to the transmission interfaces inside are arranged differently, the user cannot choose the headset according to their preference, and is restricted by the manufacturer.

### SUMMARY OF THE INVENTION

It is therefore a primary object of the present invention to provide an electronic device capable of automatically determining a headset type and method thereof.

The present invention discloses an electronic device capable of automatically determining a headset type. The electronic device includes a headset jack, a detection unit and a discrimination unit. The headset jack includes a plurality of transmission interfaces and is used for exchanging signals with a headset via the plurality of transmission interfaces. The detection unit is coupled to the headset jack and is used for detecting the signals exchanged via the plurality of transmission interfaces. The discrimination unit is coupled to the detection unit and is used for determining the signal allocation of the headset according to the signals exchanged via the plurality of transmission interfaces.

The present invention further discloses a method of automatically determining a headset type. The method includes the following steps. First, signals are exchanged with a headset via a plurality of transmission interfaces of a headset jack. The signals exchanged are detected via the plurality of transmission interfaces. Finally, the signal allocation of the headset is determined according to the signals exchanged via the plurality of transmission interfaces.

The present invention further discloses an electronic device capable of automatically determining a headset type. The electronic device comprises a four-segment headset jack, a detection unit, and a discrimination unit. The four-segment headset jack includes a plurality of transmission interfaces for exchanging signals with a headset via the plurality of transmission interfaces. The detection unit is coupled to the four-segment headset jack and used for detecting the signals exchanged via the plurality of transmission interfaces. The discrimination unit is coupled to the detection unit and used for determining the signal allocation of the headset according to the signals exchanged via the plurality of transmission interfaces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of signals and connections of a three-segment headset plug, a four-segment headset plug, and a four-segment headset jack according to the prior art.

FIG. 2 is a schematic diagram of an electronic device capable of automatically discriminating a headset type according to an embodiment of the present invention.

FIG. 3 is a look-up table for determining the headset type according to the embodiment of the present invention.

FIG. 4 is a flowchart of a preferred process for automatically determining the headset type according to the look-up table in FIG. 3.

### DETAILED DESCRIPTION

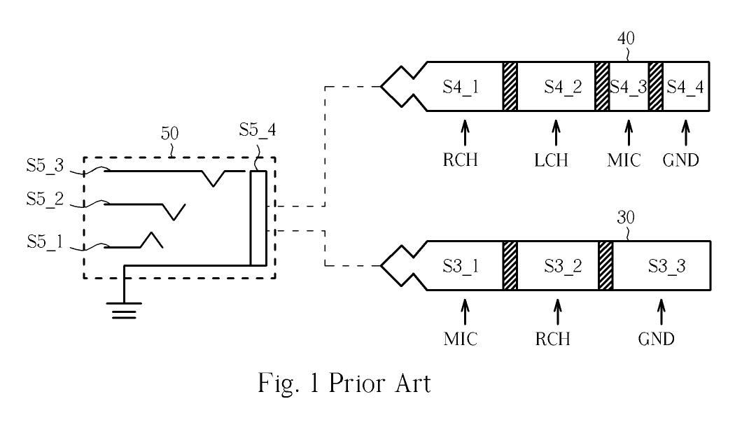

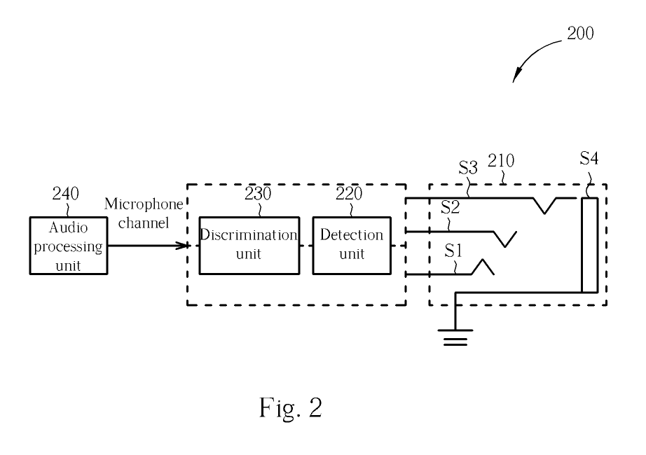

Please refer to FIG. 2, which is a schematic diagram of an electronic device 200 capable of automatically discriminating a headset type according to an embodiment of the present invention. The electronic device 200 can be applied to any electronic product requiring a headset with a microphone function, such as a mobile phone, a personal digital assistant (PDA), and so on. An audio processing unit 240 commonly installed in the electronic product is coupled to the electronic device 200. The electronic device 200 includes a headset jack 210, a detection unit 220, and a discrimination unit 230. The headset jack 210, similar to the four-segment headset jack 50 shown in FIG. 1, includes transmission interfaces S1-S4, and is used for exchanging a left-channel signal LCH, a right-channel signal RCH, a microphone signal MIC, and a grounding signal GND with a headset. The detection unit 220 is coupled to the headset jack 210 and is used for detecting signals exchanged via the transmission interfaces S1-S4. The discrimination unit 230 is coupled to the detection unit 220 and is used for determining signal allocation of the headset, so as to discriminate that a type of a headset plugged into the headset jack 210 is three-segment or four-segment according to the signals exchanged via the transmission interfaces S1-S4. The detection unit 220 and the discrimination unit 230 can be implemented as an IC chip (such as a single chip 8051), an analog switch, or an embedded system.

Via the electronic device 200, the detection unit 220 first detects voltage variation of the transmission interface S4, which is grounded, when the headset is plugged into the headset jack 210, and thereby determines whether the headset is successfully coupled to the headset jack 210. After that, the discrimination unit 230 determines the signal allocation of the headset according to the signals exchanged via the transmission interfaces S1-S4, and the audio processing unit 240 then correctly processes the left-channel signal LCH, the right-channel signal RCH and the microphone signal MIC based on the headset type. In other words, the discrimination unit 230 determines the signal allocation of the headset, so as to control the left-channel signal LCH, the right-channel signal RCH, and the microphone signal MIC to transmit via accurate channels, so that each signal of the headset can be transmitted to the audio processing unit 240 via matching transmission interfaces, or corresponding segments. On the contrary, the left-channel signal LCH, the right-channel signal RCH, and the microphone signal MIC, which are processed by the audio processing unit 240, can correctly be transmitted to the headset via the matching transmission interfaces.

Preferably, the present invention utilizes the transmission interface used for exchanging the microphone signal MIC to determine the headset type. After the detection unit 220 has confirmed that the headset is successfully plugged into the headset jack 210, the discrimination unit 230 switches the transmission interfaces S1-S3 of the headset jack 210 one-by-one to couple each transmission interface S1-S3 to a microphone channel of the audio processing unit 240. Each time coupling is performed, the detection unit 220 detects any voltage variation of the transmission interfaces S1-S3, so as to determine which transmission interface exchanges the microphone signal MIC. When the transmission interface of the headset used for exchanging the microphone signal MIC is fitted just right with the one of the transmission interfaces S1-S3 corresponding to the microphone channel, the detection unit 220 can detect the voltage variations occurring on the transmission interface corresponding to the microphone channel so as to determine the headset type. For example, suppose the four-segment headset plug 40 shown in FIG. 1 is plugged into the headset jack 210, and the discrimination unit 230 switches the transmission interfaces S1-S3 one-by-one to communicate with the microphone channel. If the microphone channel communicates with the transmission interfaces S1 and S2, the detection unit 220 detects that no voltage variation occurs. Once the microphone channel communicates with the transmission interface S3, the detection unit 220 detects voltage variation occurring on the transmission interface S3. In comparison with the above, if the three-segment headset plug 30 shown in FIG. 1 is plugged into the headset jack 210, the detection unit 220 can detect voltage variation when the microphone channel communicates with the transmission interface S1 or S3, since the transmission interface S3_3 of the three-segment headset plug 30 is coupled to the ground.

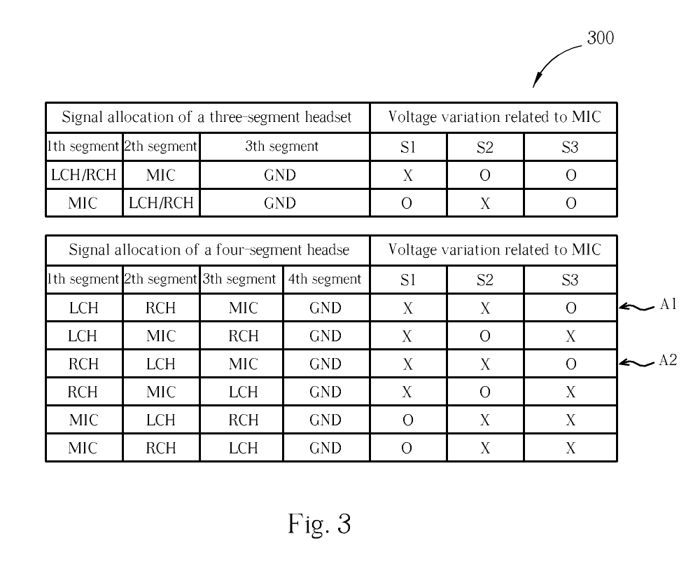

As a result, a look-up table can be established in the discrimination unit 230 according to the conditions under which the microphone signal triggers voltage variation to occur or not to occur on each transmission interface S1-S3. The discrimination unit 230 can determine the signal allocation of the headset by querying the look-up table in comparison with a detection result of the detection unit 220. FIG. 3 is a look-up table 300 for determining the headset type according to the embodiment of the present invention. A left part of the look-up table 300 shows the signal allocation of the four-segment headset, whereas a right part of the look-up table 300 shows exemplary detection results, in which voltage variation occurs (O) or does not occur (X) on the transmission interfaces for each possible coupling condition.

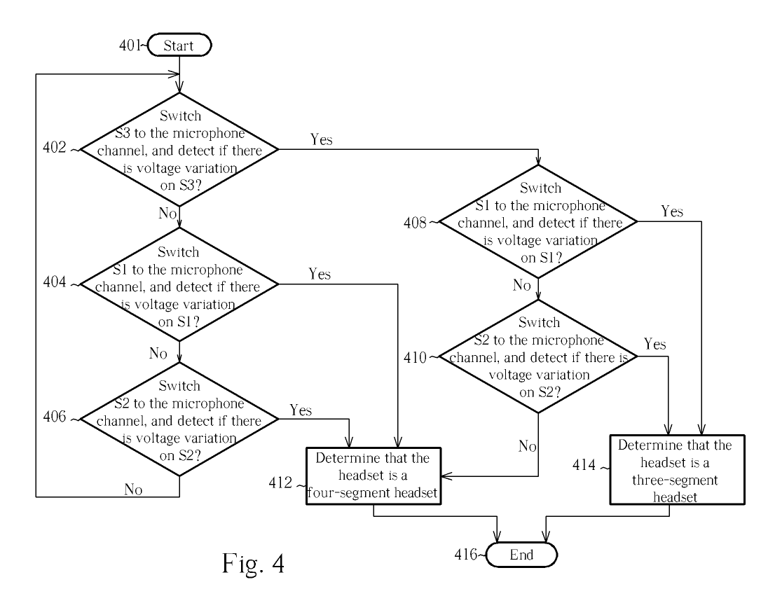

Please refer to FIG. 4, which is a flowchart of a process 400 for automatically determining the headset type according to the look-up table 300. The process 400 includes the following steps:

Step 401: Start.

Step 402: Switch the transmission interface S3 to communicate with the microphone channel, and detect if there is any voltage variation on the transmission interface S3. If so, go to Step 408; if not, go to Step 404.

Step 404: Switch the transmission interface S1 to communicate with the microphone channel, and detect if there is any voltage variation on the transmission interface S1. If so, go to Step 412; if not, go to Step 406.

Step 406: Switch the transmission interface S2 to communicate with the microphone channel, and detect if there is any voltage variation on the transmission interface S2. If so, go to Step 412; if not, go to Step 402.

Step 408: Switch the transmission interface S1 to communicate with the microphone channel, and detect if there is any voltage variation on the transmission interface S1. If so, go to Step 414; if not, go to Step 410.

Step 410: Switch the transmission interface S2 to communicate with the microphone channel, and detect if there is any voltage variation on the transmission interface S2. If so, go to Step 414; if not, go to Step 412.

Step 412: Determine that the headset is a four-segment headset.

Step 414: Determine that the headset is a three-segment headset.

Step 416: End.

According to the process 400, voltage variation on a transmission interface indicates that the transmission interface is used for exchanging the microphone signal, and thereby the headset type can be determined from the look-up table 300. When the headset plug is securely coupled to the headset jack 210, the transmission interface S3 is switched to the microphone channel, and voltage variation occurring on the transmission interface S3 is detected. If voltage variation is detected on the transmission interface S3, the transmission interfaces S1 and S2 are switched to the microphone channel for detecting if any voltage variation occurs on the transmission interfaces S1 and S2. The headset will be determined as a three-segment headset if voltage variation is detected on either of the transmission interfaces S1 and S2; on the contrary, the headset will be determined as a four-segment headset if no voltage variation is detected on the transmission interfaces S1 and S2. Similarly, under the circumstance of no voltage variation detected on the transmission interface S3, the headset is determined as a four-segment headset when voltage variation is detected on either of the transmission interfaces S1 and S2. In Step 406, no voltage variation detected on the transmission interface S2 implies that none of the transmission interfaces S1-S3 is used for exchanging the microphone signal. Under this circumstance, the headset type is indeterminate, so that a restart of the whole process is performed. Steps 412 and 414 take action to compare the detection results of the preceding steps (Step 402-Step 410) with the look-up table 300 for determining the headset type. For example, when a headset is plugged into the headset jack 210, only the transmission interface S3 exhibits voltage variation, which shows that the headset utilizes the transmission interface S3 to exchange the microphone signal. Further, compared with the look-up table 300, we can find that ‘A1’ and ‘A2’ labeled in FIG. 3 conform to the detection result, whereby it is determined that the headset is four-segment.

Please note that in the four-segment headset, the transmission interface S3 has voltage variation when both of the transmission interfaces S1-S2 have no voltage variation, as can be seen from the look-up table 300. On the contrary, in the three-segment headset, if voltage variation is detected on the transmission interface S3, voltage variation can also be detected on one of the transmission interfaces S1-S2. The process 400 is a preferred embodiment of the present invention, since the process 400 detects the voltage variation on the transmission interface S3 of the headset jack 210 first, which allows the detection unit 220 to detect the transmission interfaces the least number of times. Therefore, system resources can be saved. Certainly, the present invention can perform detection of voltage variation on the transmission interfaces in a different order, or can detect more than one transmission interface at once. For example, the present invention could simultaneously perform detection of voltage variation for two transmission interfaces. Alternatively, the present invention could detect the type of signal exchanged for each transmission interface at a time, and then determine the headset type according to the look-up table. For the sake of brevity, manner and order of detection or determination can be modified if necessary, and are not limited to being based on the microphone signal, or to detecting voltage variation on a transmission interface only once.

To summarize, the present invention provides an electronic device and related method for determining a headset type, which automatically determines that the headset plugged into the headset jack is a three-segment or four-segment headset according to signals exchanged via the transmission interfaces of the headset jack. Therefore, the present invention can increase adaptability of electronic products equipped with a headset jack to three-segment and four-segment headsets, such that users can choose three-segment or four-segment headsets according to their preference without being restricted to the headsets sold with the electronic products.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device capable of automatically determining a headset type comprising:
a headset jack comprising a plurality of transmission interfaces, for exchanging signals with a headset via the plurality of transmission interfaces;
a detection unit coupled to the headset jack, for detecting the signals exchanged via the plurality of transmission interfaces; and
a discrimination unit coupled to the detection unit, for determining the signal allocation of the headset according to the signals exchanged via the plurality of transmission interfaces.

2. The electronic device of claim 1, wherein the headset jack is a four-segment headset jack.

3. The electronic device of claim 1, wherein the discrimination unit determines the headset type according to a segment location of a first transmission interface of the plurality of transmission interfaces.

4. The electronic device of claim 3, wherein the first transmission interface is used for transmitting a microphone signal.

5. The electronic device of claim 1, wherein the discrimination unit is used for querying a look-up table according to the signals exchanged via the plurality of transmission interfaces, so as to determine the signal allocation of the headset.

6. The electronic device of claim 1, wherein the headset is a three-segment headset.

7. The electronic device of claim 1, wherein the headset is a four-segment headset.

8. A method of automatically determining a headset type comprising:
exchanging signals with a headset via a plurality of transmission interfaces of a headset jack;
detecting the signals exchanged via the plurality of transmission interfaces; and
determining the signal allocation of the headset according to the signals exchanged via the plurality of transmission interfaces.

9. The method of claim 8, wherein the headset jack is a four-segment headset jack.

10. The method of claim 8, wherein determining the headset type according to the signals of the plurality of transmission interfaces is determining the headset type according to a segment location of a first transmission interface of the plurality of transmission interfaces.

11. The method of claim 10, wherein the first transmission interface is used for transmitting a microphone signal.

12. The method of claim 8, wherein determining the headset type according to the signals of the plurality of transmission interfaces is querying a look-up table according to the signals of the plurality of transmission interfaces, so as to determine the signal allocation of the headset.

13. The method of claim 8, wherein the headset is a three-segment headset.

14. The method of claim 8, wherein the headset is a four-segment headset.

15. An electronic device capable of automatically determining a headset type comprising:
a four-segment headset jack comprising a plurality of transmission interfaces for exchanging signals with a headset via the plurality of transmission interfaces;
a detection unit coupled to the four-segment headset jack, for detecting the signals exchanged via the plurality of transmission interfaces; and
a discrimination unit coupled to the detection unit, for determining the signal allocation of the headset according to the signals exchanged via the plurality of transmission interfaces.

16. The electronic device of claim 15 further comprising an audio processing unit coupled to the discrimination unit for processing a microphone signal, a left-channel signal, and a right-channel signal, which are transmitted via the plurality of transmission interfaces.

17. The electronic device of claim 16, wherein the discrimination unit is used for controlling transmission channels of the microphone signal, the left-channel signal, and the right-channel signal according to signal allocation of the headset.

18. The electronic device of claim 16, wherein the discrimination unit determines the headset type according to any of the plurality of transmission interfaces generating voltage variation in response to the microphone signal.

19. The electronic device of claim 15, wherein determining the headset type according to the signals exchanged via the plurality of transmission interfaces is querying a look-up table according to the signals exchanged via the plurality of transmission interfaces, so as to determine the signal allocation of the headset.

20. The electronic device of claim 15, wherein the headset is a three-segment headset.

21. The electronic device of claim 15, wherein the headset is a four-segment headset.
